(19) United States
(12) Patent Application Publication
(10) Pub. No.: US 2010/0227292 A1
(43) Pub. Date: Sep. 9, 2010

(54) Dental Chair Having An Accessory Unit With An Adjustable Support Device

(76) Inventor: Tom Benfield, York, SC (US)

Correspondence Address: Timothy H. Van Dyke;Beusse Wolter Sanks Mora & Maire, P.A., 390 North Orange Avenue, Suite 2500, Orlando, FL, 32801, US

(21) Appl. No.: 12/397,687

(22) Filed: Mar. 4, 2009

(51) Int. Cl. A61G 15/00; A47C 7/54

(52) U.S. Cl. 433/33; 297/411.31

(57) ABSTRACT

Disclosed is a dental chair and accessory unit that includes an adjustable support device that can be quickly and easily configured for either left hand or right hand operation and requires a minimum of valuable office floor space without resorting to expensive and time consuming disassembly and reassembly of the support device while providing a secure and stable support for the DAU. Also disclosed is a DAU with an adjustable support device as described above, configured for retrofit to an existing dental chair.

### FIELD OF THE INVENTION

The present invention provides a dental chair that includes an accessory unit with an adjustable support device.

### BACKGROUND OF THE INVENTION

A typical dental procedure room is ten feet by eight feet which must accommodate various items, such as a dental procedure chair, a Dental Accessory Unit (DAU), an operator, e.g. a dentist and/or dental assistant, storage cabinetry and any further dental equipment. Therefore, floor space in the dental procedure room is at a premium.

Traditionally, the DAU can support such accessories as, but not limited to, a cuspidor, dental assistants instrumentation and a dental light. Such DAU's have been traditionally arranged adjacent to the dental procedure chair in a predetermined right or left hand side configuration based on the preference and/or needs of the operator.

DAU's have also been supported by a movable support device that would allow limited movement of the DAU along the particular side of the examination chair that the support device was configured for, e.g. the right hand side or the left hand side. Reconfiguring a pre-configured right hand side support device and DAU for left hand side operation, or vice a versa, typically required extensive time, effort and expense. Therefore reconfiguration of a configured support device on a short term basis, e.g. temporary use of a left hand configured DAU by a right handed operator, was not a practical consideration.

### SUMMARY OF THE INVENTION

The present invention provides a dental chair and accessory unit that includes an adjustable support device that can be quickly and easily configured for either left hand or right hand operation and requires a minimum of valuable office floor space.

One embodiment of the present invention is a dental chair having a dental accessory unit movably mounted thereon for being selectively positioned at either the left-hand or right-hand side of the chair to facilitate dental procedures to be performed by a dental practitioner. The dental chair having a seat portion configured to support a dental patient, and a base sized and configured to support the seat portion. The support device is attached at a rear area of the base, the support device having a first arm member and a second arm member movably mounted on the base for movement in a generally horizontal plane. The support device also has a first pivot joint arranged between the base and the first arm member, with the first pivot joint being positioned to rotate about a first axis generally perpendicular to the horizontal plane, a second pivot joint arranged between the first and second arm members, with the second pivot joint being positioned to rotate about a second axis generally perpendicular to the horizontal plane, a DAU being carried on the second arm member, a third pivot joint arranged between the second arm member and the DAU, with the third pivot joint being positioned to rotate about a third axis generally perpendicular to the horizontal plane, and a locking device for each of the pivot joints for selectively locking the pivot joint in either one of two predetermined angular locking positions, wherein the support device facilitates folding of the arm members and the dental accessory unit in an operative position at either the left or right side of the dental chair.

In a further aspect of the invention, the adjustable support device may also be configured to pivot from a right side to a left side of the dental chair, or vice a versa, while remaining closely adjacent to the dental chair during the transition from one side to the other and also include one of the pivot joints with a master locking device and the each of the other pivot joints each comprise a slave locking device with the locking devices being interconnected so that configuring the master lock device to an unlock mode enables the slave lock devices to be unlocked. The master locking device may also include a release handle. Furthermore, at least one of the locking devices may include a biasing mechanism for biasing the one locking device to a locking mode that automatically locks once the pivot joint is moved to a locking position.

In a further aspect of the invention, the dental chair with an adjustable support device may further include a chair control system configured to control a position of the seat portion. The dental chair may further include a safety switch system that includes a plurality of safety switches in communication with the chair control system where the safety switch system is configured to provide a safety switch control signal to the control system and the control system is configured to prevent the seat portion from moving if the control system determines that the support device is in a motion path of the seat portion, based on the safety switch control signal.

In a further aspect of the invention, each locking device may include a locking cam plate and an associated locking bolt. Furthermore, each locking device may be actuated via push/pull control cables that are in communication with the release handle.

Another embodiment of the present invention is an adjustable support device adapted to be mounted on a dental chair for selectively positioning a dental accessory unit either at the left-hand or right-hand side of the dental chair to facilitate dental procedures to be performed by a dental operator, the adjustable support device including a first arm member and a second arm member to be movably mounted on the dental chair for movement in a generally horizontal plane, a first pivot joint arranged between the dental chair and the first arm member, with the first pivot joint being positioned to rotate about a first axis generally perpendicular to the horizontal plane, a second pivot joint arranged between the first and second arm members, with the second pivot joint being positioned to rotate about a second axis generally perpendicular to the horizontal plane, a DAU being carried on the second arm member, a third pivot joint arranged between the second arm member and the DAU, with the third pivot joint being to rotate about a third axis generally perpendicular to the horizontal plane, and a locking device for each of the pivot joints for selectively locking the pivot joint in either of two predetermined angular locking positions, wherein the support device facilitates folding of the arm members and the dental accessory unit toward the dental chair in an operative position at either the left or right side of the dental chair.

In a further aspect of the invention, the one of the pivot joints may include a master locking device and each of the other pivots may include a slave locking device with the locking devices being interconnected so that configuring the master lock device to an unlock mode enables the slave locking devices to be unlocked. At least one of the locking devices may further include a biasing mechanism for biasing the locking device to a locking mode. Also, the master locking device may include a release handle, and the master locking device may automatically lock once the pivot joint is moved to a locking position, and each locking device may be actuated via push/pull control cables that are in communication with the release handle.

### BRIEF DESCRIPTION OF THE DRAWINGS

The above-mentioned and other concepts of the present invention will now be described with reference to the drawings of a preferred embodiment of the present invention of the dental chair having an adjustable support device. The illustrated embodiments of the dental chair and adjustable support device are intended to illustrate, but not limit the invention. The drawings contain the following figures:

FIG. 1 shows a side view of the dental chair having the adjustable support device;

FIG. 2 shows an isometric view of the adjustable support device;

FIG. 3 shows a simplified exploded view of the adjustable support device;

FIG. 4 shows a top down view of the adjustable support device in motion;

FIG. 5 shows a detailed view of the locking plates.

### DETAILED DESCRIPTION OF THE INVENTION

In a dental clinical setting, a typical dental procedure room includes a dental chair 11 with a DAU 27. The dental chair 11 operates to provide a stable and comfortable support for a dental patient during a dental examination or procedure. The DAU 27 is capable of, but not limited to, supporting such accessories as a cuspidor, dental assistants instrumentation and a dental light to assist the dental staff during clinical procedures.

The invention described herein employs one or more basic concepts. For example, one concept relates to a dental chair and DAU with an adjustable support device. A benefit of the inventive device is the ability to reconfigure the position of the DAU from one side of the dental chair to the other while securely supporting the DAU. More specifically, the ability to reconfigure the position of the DAU from one side of the dental chair to the other quickly and easily while requiring a minimum of floor space and without resorting to expensive and time consuming disassembly and reassembly of the support device while providing a secure and stable support for the DAU. Another concept of the present invention relates to a DAU with an adjustable support device as described above, configured for retrofit to an existing dental chair.

While the present invention is disclosed in the context of a dental apparatus having an adjustable support device designed to securely support a DAU. The principles of the present invention, however, are not limited to use within a dental apparatus or the dental or medical fields. One skilled in the art may find additional applications for the apparatus, and configurations disclosed herein. Thus the illustration and description of the present invention in context of the exemplary dental chair with DAU having an adjustable support device and a retrofittable DAU having an adjustable support device are merely two possible applications of the present invention. However the present invention has particular applicability for use as a stable adjustable support device for a DAU.

### Components

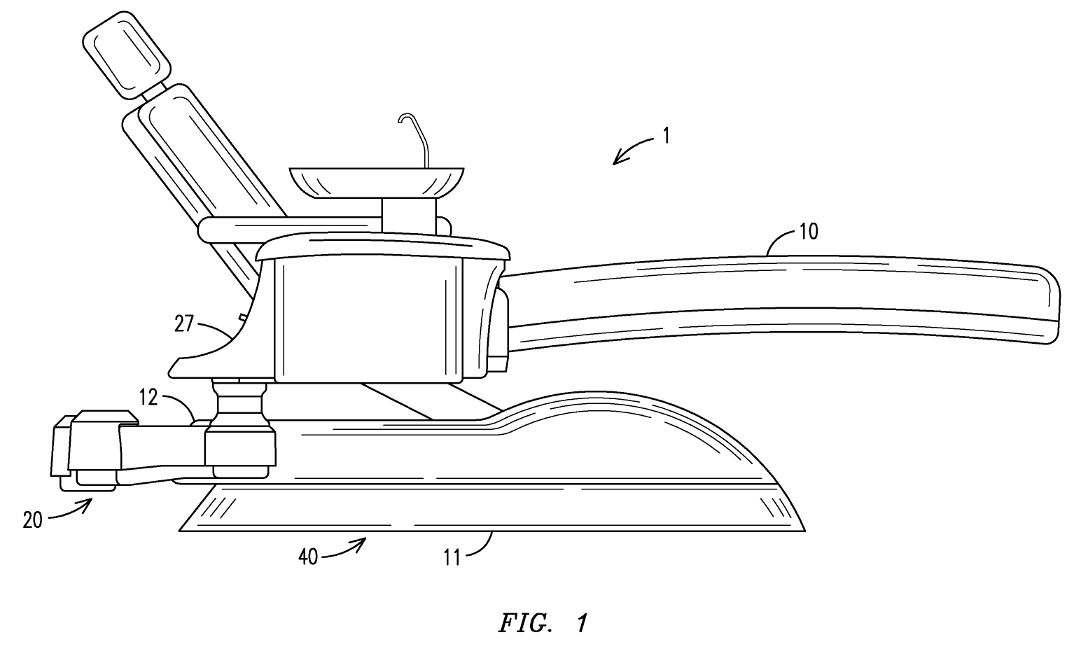

An overview of the invention is provided below followed by a more detailed description. Referring to FIG. 1, the dental chair 1 has a movable seat portion 10 and a base portion 11 that supports the movable seat portion 10. The base portion 40 houses a chair control system that controls the motion of the movable seat portion 10. Attached at a rear portion 12 of the dental chair base 11 is an adjustable support device 20 that supports a DAU 27.

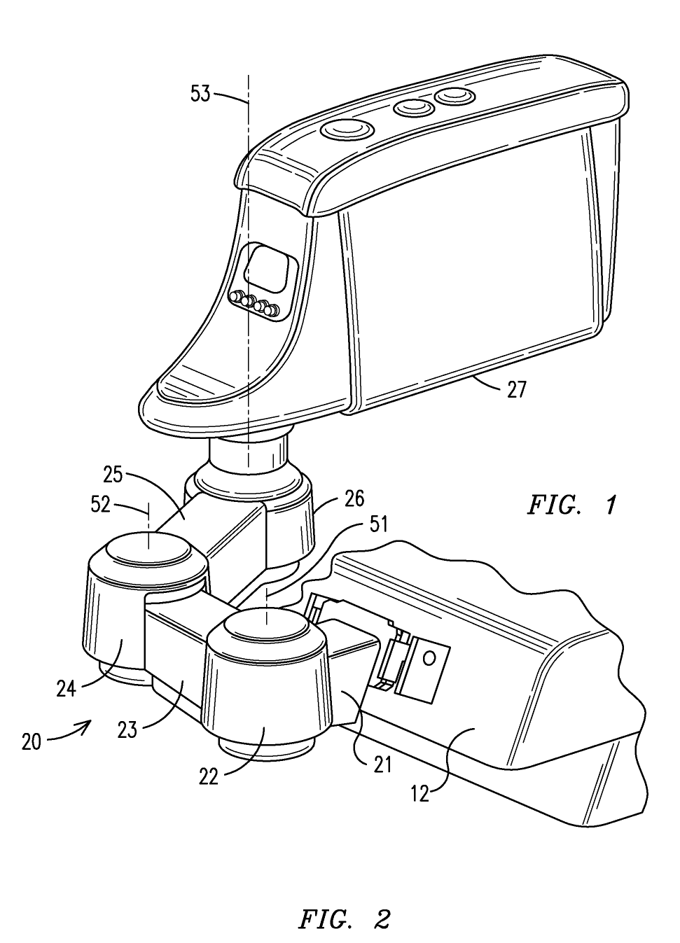

FIG. 2 shows an isometric view of the DAU 27 attached to the rear portion 12 of the dental chair base 11 by the adjustable support device 20. The adjustable support device 20 comprises an attachment member 21 that secures the adjustable support device 20 to the dental chair base 11. The adjustable support device 20 further comprises a first pivot joint 22 arranged between the attachment member 21 and a first movable arm member 23. A second pivot joint 24 is arranged between the first movable arm member 23 and a second movable arm member 25. A third pivot joint 26 is arranged at an end of the second movable arm member 25 and attaches the DAU to the adjustable support device 20.

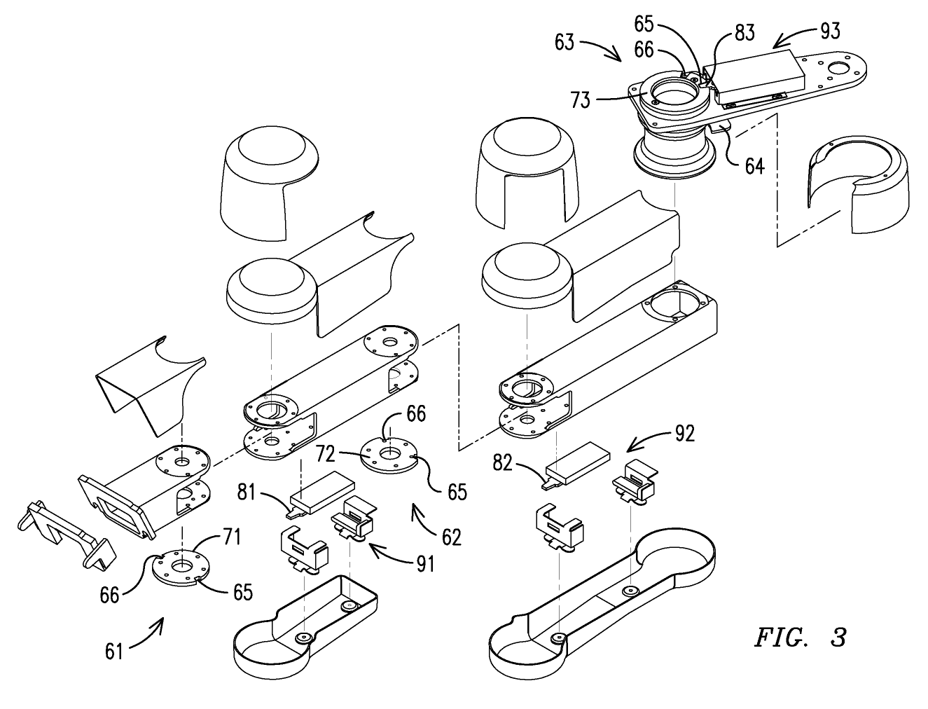

FIG. 3 shows an exploded view of the adjustable support device 20 in simplified form. Each pivot joint 22, 24, 26 includes a locking mechanism 61, 62, 63. The locking mechanism may be any device that effectively locks the pivot joints 22, 24, 26 in a right hand or left hand position while allowing the adjustable support device 20 to collapse into a minimum size during the transition between the right and the left side configuration, or vice a versa. Furthermore, each pivot joint 22, 24, 26 comprises a bearing mechanism (not shown for clarity) such as journal or roller bearings. Preferably, the bearing mechanisms are tapered roller bearings however, any suitable bearing device may be utilized such that the pivot joint is rotatably and securely supported.

In a preferred embodiment of FIG. 3, each locking mechanism 61, 62, 63 comprises a locking plate 71, 72, 73 respectfully, and an associated locking bolt 81, 82, 83 respectfully. Each locking mechanism fixes an angular position of the respective pivot joint when engaged. Each movable arm member 23, 25 further includes safety switches 91, 92, 93 that cooperate with the respective locking bolt 81, 82, 83 and communicate with the control system 40 of the dental chair 1 to prevent a collision between the movable seat portion 10 and the DAU 27 and support device 20.

### Operation

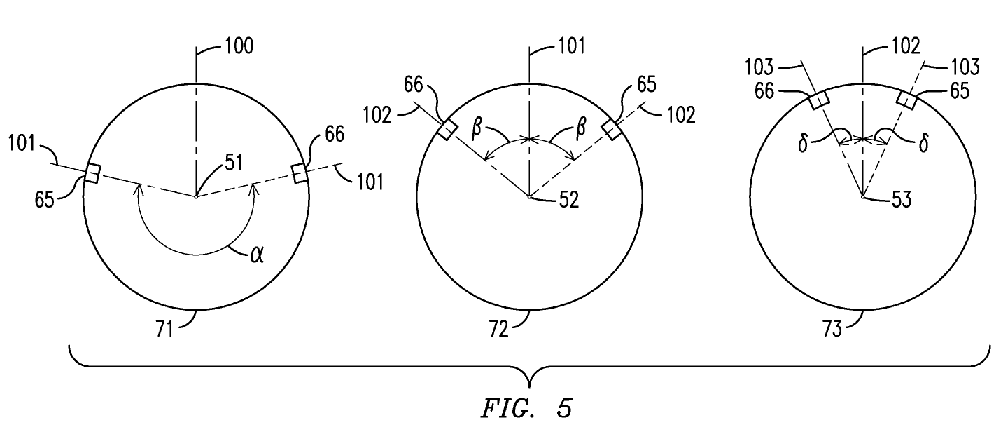

The inventive dental chair 1 and DAU 27 with an adjustable support device 20 employs attachment member 21, first movable member 23 and second movable member 25 and first pivot joint 22, second pivot joint 24, and third pivot joint 26, as discussed above and seen in FIGS. 1 and 2. The movable arm members 23, 25 and DAU 27 move in a horizontal plane perpendicular to the pivot axes 51, 52, 53 of the three pivot joints 22, 24, 26. Furthermore, the pivot axes 51, 52, 53 are essentially parallel with one another and essentially vertical to facilitate the movable arm member 23, 25 motion in the horizontal plane. The adjustable support device 20 is configured to facilitate folding of the arm members and the dental accessory unit in a collapsed left or right hand side configuration relative to the dental chair 1 via rotation about the pivot joints 22, 24, 26 as seen in FIG. 5.

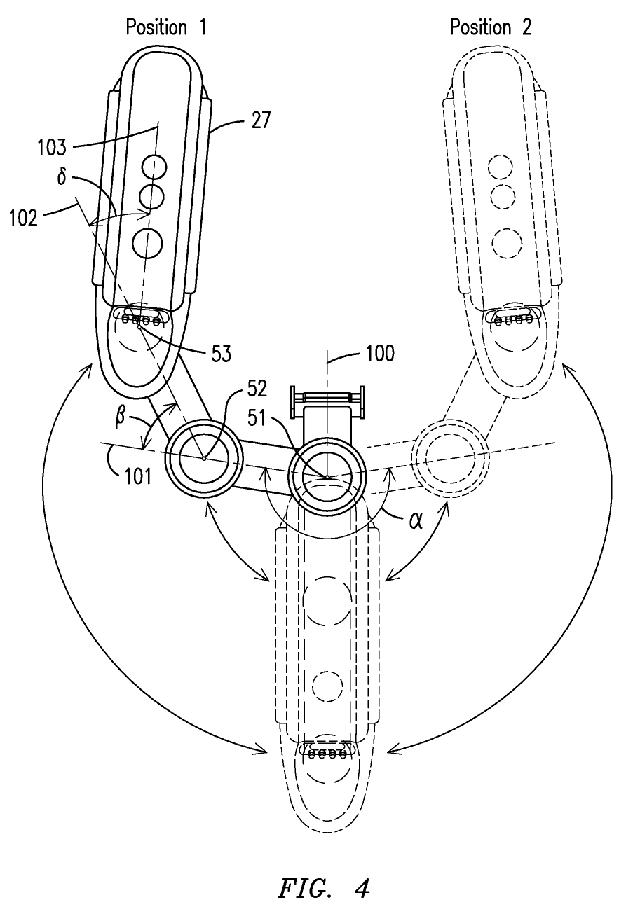

Referring to the preferred embodiment of FIG. 3, each pivot joint 22, 24, 26 of the adjustable support device 20 includes a locking mechanism 61, 62, 63 that limits the rotation of each respective joint. Each locking mechanism 61, 62, 63 includes a respective locking plate 71, 72, 73 that comprises a flat circular plate having an inner and outer diameter and a first radial slot 65 corresponding to a left hand side configuration of the DAU, and a second radial slot 66 corresponding to a right hand side configuration of the DAU. The radial slots 65, 66 are each configured to receive a mating end of the locking bolt 81, 82, 83 which limits the rotation of the respective joint to the angle defined between the two radial slots 65, 66, as seen in FIG. 4.

Referring to FIG. 3, when the locking bolt is engaged in either slot 65, 66, the locking mechanism 61, 62, 63 is securely locked in place preventing the pivot joint 22, 24, 26 from rotating. When the locking bolt 81, 82, 83 is actuated by a release handle 64, configured for actuation by an operator, the locking bolt is withdrawn from either slot 65, 66. Once the locking mechanism 61, 62, 63 is released, the respective pivot joint 22, 24, 26 is free to rotate to the other slot (either 65 or 66) corresponding to right hand side operating position or left hand side operating position) as seen in FIG. 4.

Referring to FIG. 3, the release handle 64 may have a sliding support that actuates the locking bolt (one of 81, 82 or 83) by withdrawing the respective bolt out of one of the radial slots 65, 66. Preferably, the respective locking bolt 81, 82 or 83 is configured to be radially withdrawn from the respective radial slot 65, 66. The respective bolt can have a return spring to provide a return force such that the respective bolt will automatically return into the other radial slot 66, 65 once the respective pivot joint has rotated through its respective indexing angle α, β, δ and the respective bolt (one of 81, 82 or 83) is aligned with the respective slot 66, 65 see FIGS. 4 and 5.

One of the three locking mechanisms (one of 61, 62 or 63) may function as a master that controls a locking and un-locking of the other two locking mechanisms. The master locking mechanism may be connected to the two slave locking mechanisms by a cable arrangement that allows the master to control the release of the two slave locking mechanisms where activation of the release handle 64 of the master locking mechanism (one of 61, 62 or 63) releases the locking bolts of the two slave locking mechanisms and allows the adjustable support device 20 and the DAU 27 to collapse into a minimum size envelope and rotate between the right and the left side configuration as seen in FIGS. 3 and 5. Furthermore, the safety switches 91, 92, 93 in communication with the control system 40 prevents a collision between the DAU 27 and the support device 20 while the chair is in motion.

1. A dental chair having a dental accessory unit movably mounted thereon for being selectively positioned at either the left-hand or right-hand side of the chair to facilitate dental procedures to be performed by a dental practitioner, the dental chair comprising:
a seat portion configured to support a dental patient, and
a base sized and configured to support the seat portion; and
a support device attached at a rear area of the base, the support device having:
a first arm member and a second arm member movably mounted on the base for movement in a generally horizontal plane,
a first pivot joint between the base and the first arm member, with the first pivot joint being positioned to rotate about a first axis generally perpendicular to the horizontal plane,
a second pivot joint arranged between the first and second arm members, with the second pivot joint being positioned to rotate about a second axis generally perpendicular to the horizontal plane,
the dental accessory unit being carried on the second arm member,
a third pivot joint between the second arm member and the dental accessory unit, with the third pivot joint being positioned to rotate about a third axis generally perpendicular to the horizontal plane, and
a locking device for each of the pivot joints for selectively locking the pivot joint in either one of two predetermined angular locking positions, wherein the support device facilitates folding of the arm members and the dental accessory unit in an operative position at either the left or right side of the dental chair.

2. The dental chair as claimed in claim 1, wherein the support device is configured to pivot from a right side to a left side of the dental chair, or vice a versa, while remaining closely adjacent to the dental chair during the transition from one side to the other.

3. The dental chair as claimed in claim 1, wherein one of the pivot joints comprises a master locking device and each of the other pivot joints comprises a slave locking device, with the locking devices being interconnected so that configuring the master lock device to an unlock mode enables the slave lock devices to be unlocked.

4. The dental chair as claimed in claim 3, wherein the master locking device comprises a release handle.

5. The dental chair as claimed in claim 1, wherein at least one of the locking devices includes a biasing mechanism for biasing it to a locking mode, and automatically locks once the pivot joint is moved to a locking position.

6. The dental chair as claimed in claim 1, further comprising a chair control system configured to control a position of the seat portion.

7. The dental chair as claimed in claim 7, further comprising a safety switch system comprising a plurality of safety switches in communication with the chair control system where the safety switch system is configured to provide a safety switch control signal to the control system and the control system is configured to prevent the seat portion from moving if the control system determines that the support device is in a motion path of the seat portion, based on the safety switch control signal.

8. The dental chair as claimed in claim 1, wherein each locking device comprises a locking cam plate and an associated locking bolt.

9. The dental chair as claimed in claim 4, wherein each locking device is actuated via push/pull control cables that are in communication with the release handle.

10. An adjustable support device adapted to be mounted on a dental chair for selectively positioning a dental accessory unit either at the left-hand or right-hand side of the dental chair to facilitate dental procedures to be performed by a dental operator, the adjustable support device comprising:
a first arm member and a second arm member to be movably mounted on the dental chair for movement in a generally horizontal plane;
a first pivot joint arranged between the dental chair and the first arm member, with the first pivot joint being positioned to rotate about a first axis generally perpendicular to the horizontal plane;
a second pivot joint arranged between the first and second arm members, with the second pivot joint being positioned to rotate about a second axis generally perpendicular to the horizontal plane;
the dental accessory unit being carried on the second arm member;
a third pivot joint arranged between the second arm member and the dental accessory unit, with the third pivot joint being to rotate about a third axis generally perpendicular to the horizontal plane; and
a locking device for each of the pivot joints for selectively locking the pivot joint in either of two predetermined angular locking positions, wherein the support device facilitates folding of the arm members and the dental accessory unit toward the dental chair in an operative position at either the left or right side of the dental chair.

11. The adjustable support device as claimed in claim 10, wherein one of the pivot joints comprises a master locking device and each of the other pivot joints comprises a slave locking device, with the locking devices being interconnected so that configuring the master lock device to an unlock mode enables the slave locking devices to be unlocked.

12. The adjustable support device as claimed in claim 11, wherein the master locking device comprises a release handle.

13. The adjustable support device as claimed in claim 12, wherein at least one of the locking devices includes a biasing mechanism for biasing it to a locking mode.

14. The adjustable support device as claimed in claim 13, wherein the master locking device automatically locks once the pivot joint is moved to a locking position.

15. The adjustable support device as claimed in claim 14, wherein each locking device is actuated via push/pull control cables that are in communication with the release handle.
